(19) United States
(12) Patent Application Publication
(10) Pub. No.: US 2017/0110112 A1
(43) Pub. Date: Apr. 20, 2017

(54) Normalized, User Adjustable, Stochastic, Lightweight, Media Environment

(71) Applicants: Madhavi Yemmela, Croton On Hudson, NY (US); Valentin Petran, Croton On Hudson, NY (US)

(72) Inventors: Madhavi Yemmela, Croton On Hudson, NY (US); Valentin Petran, Croton On Hudson, NY (US)

(73) Assignee: Artificial Perception Technologies, Inc., Croton On Hudson, NY (US)

(21) Appl. No.: 14/885,849

(22) Filed: Oct. 16, 2015

(51) Int. Cl. G10L 13/04; G10L 13/027; G10L 21/055; G10L 13/033

(52) U.S. Cl. CPC G10L 13/043; G10L 13/033; G10L 13/027; G10L 21/055

(57) ABSTRACT

Software which uses text to speech technology to perform electronic screenplays, including plays depicting debates, multi-lingual conversations, and scientific conference presentations, using one or more distinctly identifiable voices. Screenplays are stored by the software as collections of text fragments whose relationships to each other have been documented in machine readable form, so as to make it possible for the software to comply with user requests that various aspects of the presentation be altered. This includes complying with user requests to increase or decrease the level of detail of a presentation, requests to increase or decrease the information density of a presentation, and requests to present again material that has already been presented using alternative wordings. User adjustable cognitive burden allows transformation of professional development into entertainment, and highly compact normalized information representation allows storage of thousands of hours of user adjustable material on hand held electronic devices.

### CROSS-REFERENCE TO RELATED APPLICATIONS

The nonprovisional utility patent application to which this specification document pertains, claims the benefit of the provisional patent application No. 62/065,597 listed in the attached application data sheet, that was filed on 17 Oct. 2014, and that described an invention whose title was:

Automated, User Directed, Multidimensional Explanation, Presentation System

This nonprovisional utility patent application describes that exact same invention as the above cited provisional patent application. The name of the invention has been changed merely to make it more descriptive and easy to understand.

### BACKGROUND OF THE INVENTION

The rapid pace of change in many industries, especially those that involve the design and development of computer software, means that workers need to continuously learn new material in order to remain employable.

The world wide web provides convenient and cost effective access to unprecedented amounts of information however the time to use it is becoming more and more scarce. Employers routinely set deadlines which their staffs are unable to meet unless they work far more than 40 hours per week. The environments in which they work are often competitive and politicized in the sense that significant effort needs to be expended not only on production of deliverables, but also, on averting crises created by ambitious colleagues who deliberately instigate turmoil in order to create opportunities for advancement.

On some days, by the time workers leave their offices, they are too worn out to read anything complicated, yet they crave intellectual entertainment, which they satisfy by watching movies or late night comedians on television. On other days they are well rested, enthusiastic, and both willing and able to direct significant effort towards professional development. If they had the means to adjust the pace at which automated professional education systems present technical information to them, much as they can ask a human friend to slow down or pick up the pace during a conversation, and if those systems contained a much greater diversity of content that was far less expensive to produce, users could derive more pleasure from continuing education resources, and would use them more often, in other words, both on good days, and on the more prevalent bad days. The purpose of this paragraph, is not gratuitous pessimism, but rather to point out that for many workers, bad days occur frequently enough that finding ways to help them use such days more productively is not a miniscule benefit.

It has been our experience that education and entertainment are not mutually exclusive, and that speakers are most entertaining when the cognitive burden they impose on their listeners is well aligned with the listeners abilities, moods and levels of fatigue, and that speakers can more effectively adjust that burden not by talking faster, or slower, but rather, by including or omitting optional material. At the slow pace extreme, it is possible to extensively debate the meaning of each term, the purpose and implications of each concept, and to provide numerous examples illustrating usefulness, all while interspersing relevant anecdotes and jokes. Imagine for example, an entire episode of the Star Trek television show, dedicated to explaining the concept of a materialized view in a relational database. Adjusting this aspect of pace can be described as adjusting the information density of a presentation. The information density in a scientific publication is typically higher than that in a novel, which in turn is typically higher than that in a children's book. If information density is too low for people's abilities, expertise or level of fatigue, they grow bored, and if it is too high, they grow frustrated, their eyes glaze over, and they become unable to follow the material.

The entertainment value, relevance, and cognitive burden imposed by a presentation can also be adjusted by changing it's level of detail. For example, it is possible to explain what a car is by describing how to drive it rather than how to build it, and it is possible to explain the design of an automobile transmission without describing everything there is to know about metallurgy. The level of detail that one desires pertaining to any given topic depends not only on one's interests, level of fatigue, or expertise, but also on one's professional goals and job description.

We have reason to believe that people learn new subject matter more easily, and enjoy it more, when they are immersed in it in ways that allow them to simultaneously experience the comfort of familiarity, and the pleasure of novelty. This happens when repeated exposures to an environment are consistent, but not identical. For example, watching familiar characters in many episodes of a TV show is comforting, but repeatedly watching the same episode is boring. If automated professional education systems were able to describe the same material in a different way each time it is presented, they would more closely simulate this aspect of reality. A person who misunderstood one description of an idea, might not misunderstand alternative descriptions, especially if those ideas were presented in the form of debates containing questions, answers and objections, that illustrated potential points of confusion, and that were being conducted by likable and familiar characters.

To a certain extent, we can experience adjustable information density, adjustable level of detail, and variability of word choice by, reading different web pages or books, pertaining to the same topic, however finding a publication which uses different words to describe the exact same concept that one happened to read in a specific place, for example pg 130 of Real and Complex Analysis by Walter Rudin, is neither easy nor convenient.

Authors of traditional media must often make hard choices, because they want to neither bore nor frustrate the lowest common denominators of their audiences. If they had available for their use, a more end-user configurable medium, in which they could rely on the presentation system to assemble their content according to the reader's information detail, and information density preferences, and to do so in a slightly different fashion during each presentation of the material, they would not feel pressured to compromise. They would not have to attempt to choose one best wording. They could instead provide several equivalent wordings.

Consumers of such flexible media, would have the freedom to adjust the pace of a presentation to a tedious crawl in order to fill sporadic gaps in their knowledge, without having to endure such a pace throughout the entire presentation.

If such media were highly portable, and could be consumed passively while doing other things, knowledge workers would not have to make hard choices between professional development, physical fitness, sleep, and pleasure.

If the time, and effort, needed to create such material were far lower, more diverse, specialized content would exist.

### BRIEF SUMMARY OF THE INVENTION

The invention disclosed by this patent application is focused on providing people with the means to create, consume, store, safeguard and disseminate, a new kind of media which like a movie or audio recording can be passively consumed for entertainment, but that is far more compact, and configurable.

This new media is normalized, and user adjustable in the sense that it is comprised of many aspects, that are stored separately, and can be combined according to the end user's preferences by a specialized media player, at the time the information is consumed, rather than when it is being created.

For example, the intellectual content, (in the form of screenplays that depict conversations), is stored separately from those aspects of the media (like high definition video, still images, audio sound effects and background music) that are focused on creating a pleasant ambiance. Also various aspects of that intellectual content are stored in separate data structures. It is this modularity that makes it possible for end-users to control both the level of detail and the information density of the material being presented to them, not unlike the way they might control their perception of terrain over which they are flying in a light plane, by going higher or lower, or faster or slower.

This new media environment is stochastic, in the sense that the intellectual content component of the media may contain arbitrarily many alternative wordings of each presented concept, which in turn makes it possible for the media player to select a specific wording at random, when the media is consumed. This can make repeated consumption of a single piece of media more comparable to repeated discussion of a concept with a friend, than to the unpleasant mind numbing task of repeatedly reading a page of pedantic text in an obtuse book. This functionality also makes it possible for the media player to comply with user requests that it present again using different words, information that it has already presented.

The media environment is lightweight in the sense that it does not place great demands on either the equipment that is used to create, store, play or disseminate the media, nor on the authors who create that media, nor on the end users who consume it. For example by relying extensively on ordinary text files it is possible to store several thousand hours of content in far less space than would be required by a comparable amount of pre-recorded audio or video. Also, the architecture of the environment makes it possible for users to adjust the density, level of detail, and other aspects of the information being presented to them without requiring computationally intensive natural language processing capabilities.

Together, all of the above described features make it possible for people to both author and enjoy vast repositories of intellectual content that are well aligned with their preferences, without being burdened by a need to carry bulky equipment, and to do so in environments where that is not usually possible, for example, while exercising in remote scenic environments, while commuting to work on public transportation, or while traveling in underdeveloped areas where telecommunications network performance is very bad.

By providing people with the means to transform professional development into highly portable entertainment, this invention makes it possible for them to greatly enhance their job security and peace of mind, without having to give up exercise, entertainment, or sleep.

### BRIEF DESCRIPTION OF DRAWINGS

Artificial Perception Technologies, Inc. has designed, implemented and tested a fully functional software product named LiquidSpeech that has the above described capabilities. It is currently being marketed for portable computing devices equipped with the iOS operating system, (like the Apple iPhone and iPad), and is currently being tested on traditional full fledged computers equipped with the Apple OS X and Microsoft Windows operating systems. The latter products are focused on presenting professional development content that is intended for consumption as bed-time entertainment displayed on large high definition television sets as well as discussions of complex technical diagrams and corporate training materials displayed on large screen laptops.

The attached drawings section, is comprised of a single page containing 4 figures each depicting a portion of the user interface of the iPhone version of the LiquidSpeech software.

FIG. 1 depicts a remote control that media consumers can use to play, stop, rewind, and modify the characteristics of information that is being presented to them. They can increase information density by pressing the Rabbit icon. They can decrease information density by pressing the Turtle icon. They can increase level of detail by pressing the Down Arrow icon, and they can decrease level of detail by pressing the Up Arrow icon.

FIG. 2 depicts a user interface that media consumers can use to specify whether or not a (stop, rewind, play) operation will cause media to be presented again using different words.

FIG. 3 depicts the intellectual content component of our media, which we call a LiquidSpeech screenplay, into which commands to specify which voices should be used to read various paragraphs out loud have been inserted.

FIG. 4 depicts a custom keyboard, that media authors can use to insert commands of the above described variety into a LiquidSpeech screenplay without memorizing specialized syntax, while using the LiquidSpeech text editor to create intellectual content. Media authors can toggle between this custom keyboard, and an ordinary alphanumeric keyboard by pressing the button in the upper right hand corner of the screen that looks like a small keyboard (and is located next to the Save button)

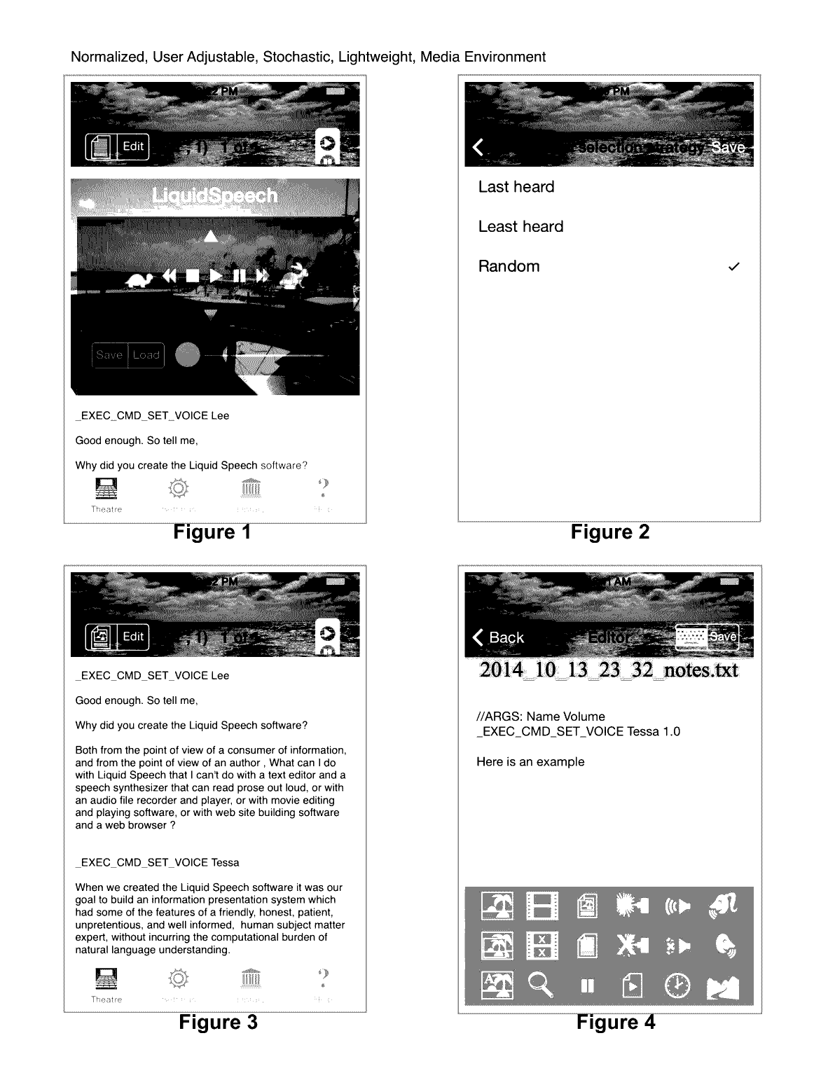

The various LiquidSpeech software implementations that currently exist, were intended to demonstrate that the above described normalized, user adjustable, stochastic, lightweight, media environment functionality is not mere wishful thinking, but can in fact be made to work, and also to verify that the resulting user experience really can provide significant entertainment while inadvertently imparting useful knowledge.

Examples of videos that we have produced using the above described LiquidSpeech software can be found by searching for the name Val Petran on the You Tube web site.

The names of two such videos are “the philosophy of probability and Humpreys' Paradox” and “#pragma”.

The #pragma video allows one to see an actual hand held device, namely an Apple iPhone 4S equipped with iOS version 7.1.2 in action, while it is performing a LiquidSpeech screenplay.

The philosophy of probability and Humphreys' paradox video demonstrates the Normalized Media user experience, that can be created by layering audio produced by LiquidSpeech over video whose purpose is only to create an ambiance and that is completely devoid of intellectual content.

The screenplays pertaining to both videos were written using the LiquidSpeech software running on a hand held device, namely the iPhone depicted in the #pragma video, not while sitting in an office, but literally while strolling on the actual beach depicted in the philosophy of probability video. We did this to convince ourselves of the truth of our hypothesis, that the compactness and portability of LiquidSpeech media actually did make it possible to not only consume technical media while exercising in scenic environments, but to create it.

### DETAILED DESCRIPTION OF THE INVENTION

### Summary of Invention Components

The invention described by this document is comprised of:

(1) a way to annotate and link fragments of text in a repository, in a machine readable form, that makes it possible for an author to ensure that given any piece of text in the repository, it is easy for software to find or fabricate other pieces of text that mean essentially the same thing but contain less detail or more detail, that have a higher or lower information density, that have been worded in different ways, and for which the extent to which arbitrarily many types of author defined aspects (such as for example humor) are included in the media can be adjusted by the end user.

(2) a piece of software which provides people with the means to create, organize, use, and safeguard such repositories.

### How to Use the Invention to Create and Edit Screenplays

Suppose you write screenplays for a living. Suppose furthermore that you like to travel a lot because doing that gives you fodder for your writing, and also that you prefer to do much of your writing in festive environments like restaurants, coffee shops, hotel lobbies and airports, or while strolling in scenic environments, or while sailing.

Suppose furthermore that you are an opportunistic person, who only writes when ideas gratuitously pop into your head. The advantage of this approach is that you never get writers block, but the disadvantage is that you must at all times be prepared to write something, and might prefer to not constantly lug a laptop around everywhere you go.

LiquidSpeech running on an iPhone can help you. It's hierarchical file system provides you with the means to store many versions of vast collections of text fragments that you have written, (several thousand hours worth) and to experiment with combining them in different ways, regardless of whether or not you have good network reception. The ability to mail files to yourself ensures that you don't have to worry about loosing work. The ability to bulk export the entire file system to your laptop when you are in your office helps you to be more productive, and the fact that all the intellectual content is represented using mere text files, not some sort of proprietary file format, greatly enhances your peace of mind. You are assured that you will be able to read your work in the distant future regardless of whether or not Apple, Microsoft, or LiquidSpeech still exist.

Best of all, just as the Apple Garage Band software gives composers a convenient and inexpensive way to preview how their work will sound if played by real musicians, the LiquidSpeech software's ability to read out loud the screenplays that you have written, using different voices, gives you a nice way to experience your work right away. You don't have to wait to see a rough cut. For greater realism you can even include sound effects, background noises, and music, without having to resort to computationally demanding multi channel audio or video editing software, that distracts you from the creative task of deciding what various characters should say.

The fact that at the touch of a button, you can listen to a half hour conversation that you have authored, rather than having to read it, reduces eye strain, increases the likelihood that you will catch errors and awkward phrases, and increases the quality of your life. You can proof something while walking and staring at the ocean, rather than sitting and staring at a screen.

### How to Use the Invention to Reduce Post Production Burden When Creating Traditional Media

Suppose you want to create a You Tube video that replicates the experience of sitting in a waterfront restaurant, staring at a sunset, and listening to your friends discuss a specific technical topic.

You could find people who are experts on that topic, and persuade them to discuss it while you video tape them in a scenic environment, however finding such experts is sometimes difficult and expensive. Alternatively if you personally have the necessary subject matter expertise, you could write a script and get some friends to perform it, however like actors, they would make mistakes, and because they are not professionals often fail to be convincing, and worst of all the entire process would be burdensome and time consuming.

Regardless of how you proceeded, it is likely that there would be a significant amount of post production work involved, that included the time consuming editing and transcoding of video using high powered computing equipment. For some projects that might be worthwhile, however, LiquidSpeech provides you with a far simpler approach.

All you have to do is use a text editor to write and tweak a LiquidSpeech screenplay until you are satisfied with it. This is very easy to do. You can get LiquidSpeech to perform that screenplay for you as often as you want, using multiple text to speech voices. Once you are satisfied, you can take a high definition camera, set it on a tripod, or affix it to a large drone, and use a portable light weight mixer to combine both natural sounds from the environment, and output from LiquidSpeech running on an iPhone, and use a short cable to route the resulting signal to the camera's audio input. You press record on the camera, and play on the iPhone resident LiquidSpeech software. As soon as the LiquidSpeech performance is over you have your video. There is no need for any post production. When using a drone you can use a microphone with a long thin cord, to pick up natural sounds close to the ground without picking up the sound of the drone.

Suppose you want to create a You Tube video that replicates the experience of being at a scientific conference, where a scientist talks about slides in an auditorium, and answers questions from the audience. You can do roughly the same thing as in the previous example, only this time, use LiquidSpeech running on an ordinary PC whose output has been redirected to a high definition television set, or to a projector in a darkened auditorium. Again press record on your camera, and play on LiquidSpeech, in order to cause it to display annotated slides that you have created while it talks about them, and once again, you do not need to spend any time on post production.

Suppose you are a subject matter expert who is a good writer, but a bad speaker, and that you want to create a You Tube instructional video that you want to distribute without appearing on camera, because you do not want that video to become a source of embarrassment for you at work. Once again, rather than recording yourself talking, flubbing your lines, and having to do many takes, and post production editing, you just record LiquidSpeech while it is performing a screenplay that you have written in an environment of your choice.

### How to Use the Invention to Facilitate Creativity

Suppose you are at a scientific conference at a large convention center. You have just watched a presentation, and are now sitting in the hallway outside one of many small auditoriums. The presentation has given you some really good ideas.

You want to write them down while they are still fresh in your mind, not only so you do not forget them, but also, because past experience has taught you that if you express your ideas clearly, either by writing them down, or by explaining them to other people, that process will trigger more ideas and keep you from getting distracted. At this juncture you don't want to bother anyone, so you decide to write.

LiquidSpeech running on your iPhone provides you with an extremely convenient way to do this, especially if you don't like to travel with a laptop, because you hate to leave it in your hotel room, or in the trunk of your car, and constantly carrying it with you is a nuisance.

You create a few folders on the LiquidSpeech file system, each pertaining to a different idea that you want to explore. You write some relevant formulas on some napkins, photograph them, and move those photos into appropriate folders. You write down the concepts you want to discuss, in the form of LiquidSpeech screenplays, and make use of the multiple voices to pose objections and document debates. To safeguard your work, you mail it to yourself. Later while walking on the beach, or waiting in the airport, you listen to and refine your work. Because the intellectual content is mere text, it is extremely compact, and so you feel free to create as many versions as you like. You are able to do this because the keys on an iPhone are so close together that much to your surprise you have gotten to the point that you can type as fast as people talk, using only one finger.

To keep from being distracted by surrounding people, you play background audio comprised of the sound of a crowd, because you have figured out that the easiest way to block out the sound of a lone human voice in an otherwise empty room, is with an audio recording of a human crowd, and to you this is both far less distracting than music and far more effective. This explains why people are able to function well in very noisy environments like trading floors. Because you have documented your ideas using ordinary text files, you do not worry that at some time in the future you will be unable to read them because they have been trapped in some sort of proprietary file format that is incomprehensible except when viewed using specialized software which may very well cease to exist in the distant future.

### How to Use the Invention to Transform Professional Development into Entertainment

It has been our experience that one of the most effective and entertaining ways to learn complex technical subject matter, is to create media that is focused on teaching it to other people, using language that is as simple as possible. However what is regarded as simple varies greatly across people. What one person regards as pedantic, is regarded by others as too vague.

In fact our personal preferences, pertaining to ideal information density and level of detail depend very much on how tired we are.

LiquidSpeech provides us with a way to write technical content in a way that will allow us to adjust its level of detail when at some time in the future we have forgotten it and want to review, or to share it with other people whose opinions regarding what constitutes ideal wording, level of detail, and information density, are different from ours.

Content is never entertaining if it's pace is not well aligned with the audience's needs, which in turn change not only across time and people, but during the course of a single presentation that talks about a variety of issues that are not all equally familiar to the listener.

People are far more likely to be entertained by content that has been created by others, if they do not have a hard time understanding it. To that end, users can ask the LiquidSpeech software to rephrase what they just heard by pressing the rewind button, on the remote control. If the Rendition Selection Strategy parameter depicted in FIG. 2 is set to “Last heard”, rewinding will behave in a traditional fashion, namely, after subsequently pressing play, users will experience again, what they just experienced. If however, that parameter is set to “Least heard” users will hear a different wording of the same concepts, provided authors have created alternative wordings.

The LiquidSpeech software was designed to further blur the line between authors and consumers of entertainment. Users can easily insert material of their choice into screen plays produced by others, for example, reminders to seek answers to specific questions in the future, or vulgar insights to vent frustrations, make material more memorable, or to entertain friends.

The time required to produce fully functional LiquidSpeech media that is ready for dissemination, pertaining to subject matter that is familiar to an author, can be just a few minutes. Furthermore, that time needs to be spent not on tedious formatting or technical configuration tasks, but rather on the pleasurable creative task of writing prose. Once that prose has been written, the media is ready to be disseminated.

### How to Build the Invention

### Implementation of Support for Lightweight Media Aspect

The LiquidSpeech software provides authors with the means to specify which voice should be used to say various lines, what supplemental visual and audio information should be presented and how it should be annotated by including a command processor, that can understand and interpret commands that authors include in their screenplays, to among other things, set voices, display still images, annotate still images, play sound effects, and play background videos, as depicted in FIG. 3.

The ability to read different statements using different voices significantly increases the entertainment value of the content, and greatly enhances the understandability of technical material, by facilitating presentation of debates and dialogues which sound like natural conversations and include objections, misunderstandings, clarifications, and disagreements.

To reduced the authoring burden, the LiquidSpeech software contains the custom keyboard depicted in FIG. 4, which makes it possible to insert machine readable commands (that choose various voices, display images, and so on) into a screenplay, without memorizing specialized syntax. Such inserted commands include editable default values accompanied by short comments which are useful for remembering what those parameters mean.

Each time the LiquidSpeech command processor executes a command that has been included in a screenplay, it uses a separate thread, for example to play background sound effects, play a video, or annotate a still image with a virtual laser pointer and some text.

The hand held device version of LiquidSpeech was intended to be a primarily auditory experience, that makes use of text to speech technology.

People who are traveling need to look around them, and often are in a position to admire the actual scenery that surrounds them. For travelers, conserving battery life and storage are far more important than housing rich media.

The advent of high quality concatenative text to speech software, makes it possible to experience text passively, in much the same way as listening to an audio recording.

LiquidSpeech media that represents intellectual content, in other words, LiquidSpeech screenplays, do not contain images, audio files, or videos. They contain only text that is to be spoken and commands to do things like set voices, and play rich media that is described using references and that is stored in separate standardized files on the LiquidSpeech file system. If LiquidSpeech can not find the rich media referenced in a command, it just ignores that command. This means that authors can mail a 30 kilobyte text file that contains a 20 minute conversation to a friend, and omit a gigabyte of rich media that is referenced by commands in that text file. If these authors have chosen their words wisely, the friend will easily be able to understand the concepts that are described in that conversation.

Although a picture is worth a thousand words, it has been our experience that carefully crafted audio presentations suffice for describing remarkably complex concepts, to the point that by the time one is in a position to look at diagrams or mathematical formulas, understanding the visually presented information is trivial.

In contrast to pre-recorded still images audio and video media, text is extremely compact, to the point that thousands of hours of material can easily be stored on a hand held smart phone and consumed in locations where wireless network bandwidth is low or non-existent.

### Implementation of Support for Normalized Media Aspect

We use the term “normalized” to refer to media in which sights and sounds depicted in a video that contains no intellectual content, and whose purpose is merely to create ambiance, are stored separately from media that contains only intellectual content, for example in the form of LiquidSpeech screenplays comprised of mere text. We refer to software like the personal computer versions of LiquidSpeech, as a Normalized Media players to communicate that they are able to combine these two kinds of media at run-time.

Normalized Media is far more compact than traditional de-normalized media such as television shows. A user can allocate 40 Gigabytes of storage on a computer to house ten hours of high definition video that contain sights and sounds completely devoid of intellectual content, and which depict strolls in scenic locations (beaches, country roads, mountain trails, meadows . . . ) and 1 Gigabyte of storage to house several thousand hours of intellectual content in the form of LiquidSpeech screenplays comprised only of text.

The user then chooses which scenery video to lay over any particular intellectual content, immediately before consuming that intellectual content, or by editing commands in the screenplay that do the same thing.

The resulting user experience is comparable to sitting on the same ocean front balcony each night, and listening to several friends discussing different topics, while staring at the ocean, and the space savings comes from using the same video footage for many conversations. In summary, unlike in most movies where viewers see actors speaking, LiquidSpeech Normalized Media provides viewers with a different kind of immersive experience. They don't see the speakers, but rather, see and hear what the speakers are supposedly seeing and hearing.

At the present time the video playback capability is only available on ordinary computers. It will be incorporated into portable hand held devices like the iPhone only at some time in the future, if and when limited battery capacity and computational power are no longer an obstacle.

### Implementation of Support for User Adjustable Stochastic Media Aspect

User adjustable information density, user adjustable level of detail, and the ability to rephrase content using different words, are achieved by using a meta-data representation language (which for the case of LiquidSpeech is XML) to document relationships between text fragments (which for the case of LiquidSpeech are stored in separate text files) that are related to each other in the ways illustrated by the following concrete example:

Let A, B, C1, C2, C3, C4, and C5 denote text fragments.

It is possible that A is related to B in the sense that both text fragments describe the same concepts using different words.

It is possible that A is related to the concatenation C123, of the text fragments C1, C2, C3 in the sense that A is a summary of C123

It is possible that the concatenation C12345 of the text fragments C1, C2, C3, C4, and C5 is related to the concatenation C123 of the text fragments C1, C2, and C3 in the sense that C12345 is a more verbose description of the same concepts as presented by C123 and has been obtained by concatenating more optional text fragments together.

In the above example, C12345 and C123 can both be regarded as more detailed descriptions of the same concepts as those described by A. The text fragment C12345 also differs from the text fragment C123 in that C12345 has a lower information density, in the sense that it makes use of more words to attempt to communicate the same concepts:

By allowing arbitrarily complex recursive use of the above described relations, LiquidSpeech provides authors with the means to express arbitrarily complex ideas in a form that is sufficiently machine readable to make it possible for a computerized information presentation system to honor user requests for less or more detail, less or more information density, and for repeated presentation of the same information using different wordings, while retaining compactness of information representation and requiring very low computational expenditure at the time of presentation. The required computational expenditure is in fact so low, that it is possible to honor user requests in real time using a hand held computing device even when it has no network connectivity.

An alternative to the above presented approach which places a greater burden on authors, but gives them more control, and a more predictable user experience, is for LiquidSpeech to provide them with the means to create and execute three dimensional collections of LiquidSpeech media files, that contain hand crafted references to each other, which allow LiquidSpeech to compute from any location in one file, the identity of the most narrowly defined concept that contains that location and exists in another file, as well as the location in that other file, where a rendition of that same concept begins.

One could argue that the meaning of a sentence, paragraph, or for that matter any text fragment, is not contained in the text fragment itself, but rather is constructed in the mind of a reader, by combining all of the readers knowledge with the text fragment, to create what in computer science is called a parse tree, and that one can say that a reader has understood a text fragment, if the parse tree that has been created in the reader's mind, is the same as the parse tree that existed in the mind of the author who wrote the text. To appreciate this later claim note that the sentence “Flying planes made her duck” can be interpreted in several different ways, including the absurd fairy tale type assertion that “flying aircraft created a pet duck that is owned by a female”, and the more likely mundane interpretation that “a female lowered her head in fright, because of a collection of low flying and presumably noisy aircraft”. This particular paragraph can be regarded as an example in which each of several possible meanings is in fact the intended meaning.

The assertion being made here is that natural language understanding is an inherently probabilistic operation, in the sense that it relies on judicious guessing on the part of the reader. Since not all readers have the same propensities and background knowledge it seems unlikely that it is possible for an author to create any single fragment of text that represents a parse tree in the authors mind, (in other words, that represents a concept which the author wishes to communicate), which is guaranteed to be interpreted as the author intended, by all who read it.

It is inevitable that some will regard the exact same piece of prose as tedious and pedantic, some will regard it as incomprehensible, and some will misunderstand it without being aware that they have misunderstood. By providing a user adjustable collection of descriptions that are related to each other in the above described ways, and for which those relationships have been documented in a machine readable way, authors can increase the probability that a much larger collection of readers will be able to enjoy, and not misinterpret their work.

What is claimed is:

1. Software which uses speech synthesizers to perform electronic screenplays, including plays depicting debates, conversations, and the kinds of presentations one typically sees at scientific conferences, using one or more distinctly identifiable voices, which may very well speak in several different languages during the course of any one presentation. These screenplays are stored by the software as collections of text fragments whose relationships to each other have been documented in machine readable form, so as to make it possible for the software to comply with user requests that various aspects of the presentation be altered. This includes complying with user requests to increase or decrease the level of detail of a presentation, requests to increase or decrease the information density of a presentation, and requests to present again material that has already been presented using alternative wordings.

2. Software that can accomplish what is described by claim 1 on this page without requiring advanced natural language processing capabilities.

3. Software that can accomplish what is described by claim 1 on this page that is sufficiently not computationally demanding, that it can run even on hand held electronic devices which do not have access to a telecommunications network.

4. Software that has the ability to store media described by claims 1 on this page in a form that is so compact, that thousands of hours of content can be stored on hand held portable electronic computing devices that have no network connectivity.

5. Software that can accomplish what is described by claim 1 on this page and has the ability to visually display text and still images to facilitate certain kinds of specialized explanations, or for example to provide scientists with the means to preview how presentations they are planning to give at conferences will be perceived by their audiences, and to experiment with various alternatives and refinements while traveling to conferences. The software can also layer pre-recorded audio and video tracks, (for example the sights and sounds of a crowd in a hotel piano bar) over the screenplay that is being performed, in order to create a pleasant ambiance, a more convincing performance, to block out distractions, or because the topic being discussed, for example a heart anomaly, is more easy to communicate when a small amount of rich media is available for reference.
